(19) United States
(12) Patent Application Publication
(10) Pub. No.: US 2019/0066195 A1
(43) Pub. Date: Feb. 28, 2019

(54) SYSTEM AND METHOD FOR EFFICIENT NAVIGATION OF AN ORDER ENTRY SYSTEM USER INTERFACE

(71) Applicant: ALDELO, L.P., Pleasanton, CA (US)

(72) Inventor: Harry TU, Pleasanton, CA (US)

(21) Appl. No.: 16/169,913

(22) Filed: Oct. 24, 2018

Related U.S. Application Data
(63) Continuation of application No. 15/295,554, filed on Oct. 17, 2016.

(51) Int. Cl. G06Q 30/06; G06F 3/0488; G06F 3/0482; G06Q 50/12

(52) U.S. Cl. CPC G06Q 30/0641; G06F 3/04886; G06Q 50/12; G06F 3/0482

(57) ABSTRACT

Systems and methods for efficient navigation of an order entry system user interface are disclosed. A particular embodiment includes: presenting a user interface on a display screen of a point-of-sale (POS) device to a user; rendering an on-screen interactive order display region in a first display area of the display screen; rendering an order entry region in a second display area of the display screen; receiving a first single user input from the user to cause the on-screen interactive order display region to expand to an expanded view so a larger portion of the content of the on-screen interactive order display region is visible to the user; and receiving a second single user input from the user to cause the user interface to restore the on-screen interactive order display region to the normally collapsed view not obscuring the order entry region.

### PRIORITY PATENT APPLICATION

This patent application is a continuation patent application drawing priority from U.S. non-provisional patent application Ser. No. 15/295,554; filed Oct. 17, 2016. This present non-provisional continuation patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2015-2016 Aldelo L.P., All Rights Reserved.

### TECHNICAL FIELD

This patent application relates to computer-implemented software systems, point-of-sale devices, order entry devices, and electronic device user interfaces according to one embodiment, and more specifically to systems and methods for efficient navigation of an order entry system user interface.

### BACKGROUND

Typical point of sale/service (POS) devices present an interface to the user that is adapted to the specific environment in which the POS device is being used. For example, a restaurant application may present a menu to a user, whether an employee or a self-service customer, that is adapted to the specific items being offered by the restaurant. A supermarket may present an interface adapted to supermarket transactions, and specifically to the transactions available at that supermarket. In addition, the point of sale operations carried out at an establishment may change from time to time in a way that makes it desirable to adapt the user interface to current needs. In addition, capabilities and configuration of a POS device may change in such a way that it is desirable to adapt the user interface to the changes. In many cases, it may be desired to adapt one or more point of sale stations to self-service operation. In all cases, it is important to provide a POS user interface that is fast and efficient to expedite the processing of POS transactions.

Existing point of sale/service (POS) or kiosk-based solutions available today represent an on-screen order (e.g., an invoice or guest check), whether or not interactive, mostly as a vertical panel occupying one third or one quarter of the touch screen display. See FIGS. 1 through 3 for examples. Some solutions render the on-screen order across the top of the touch screen display or two thirds the width of the top of the display. These solutions allow a user to scroll through the already ordered items either by touch screen finger swipes or by up and down button clicks. A challenge to the existing solutions' handling of the on-screen order is that its users are confined to the maximum height or width defined by the solution, and it expects its users to conform to its rendering limitations. The issue here is that such existing solutions do not utilize the entire touch screen display for the on-screen order access, and do not provide any faster way to access a full screen of order information. Existing solutions not offering the utilization of the entire touch screen display for on-screen order access, and lack of a fast access to such a full screen rendering, impedes its user's ability to achieve a fast and efficient use of the computerized order entry system. Instead, users are limited to having to scroll through a large order of items up and down to find the desired item to confirm and edit. Even if the existing solution provides the entire height of the touch screen display for presentation of the on-screen order information, the solution is still only using a third or a quarter of the display screen space. As a result, the conventional POS or order entry solutions greatly limit the full potential of the user interface and fail to simplify and expedite the user experience.

Existing point of sale/service (POS) or kiosk-based solutions available today allow item information access typically in two taps or more. Other conventional solutions require a user to click a small icon on an already small item button in the order entry screen to add, change, or delete order items or information. This handling of an order item information query by the conventional solutions produces an inefficient workflow; because, the user interface workflow requires two or more taps by the user on the touch screen in order to achieve the goal. Usually, the first tap is somewhere away from the second tap, which is typically an activation of the item itself. Having to click a small icon is equally inefficient, because of the small size of such an icon represented within a small item button. As a result, it is very difficult for a user to achieve these nested activations of buttons/icons when the user is in a hurry to complete a task. Worse, the user might inadvertently order an unwanted item or the wrong item without intending to do so. Additionally, some conventional systems offer a detail information view for items already ordered. However, this also presents an inefficiency; because, the user would have to void out the item if after viewing the item information, the user determines that such an item was the wrong item.

Secondly, existing POS or kiosk-based solutions allow order entry actions be invoked via clicking of designated buttons located throughout the order entry screen. Some buttons are placed in hidden areas while some others are located just about anywhere an interface developer can find a spot. Although some systems may place buttons in strategic locations to facilitate easier access, its users are still required to find the button and click it, which takes time to train new users and extends the learning curve. Efficiency and productivity isn't immediately achieved. In a fast-paced environment, such inefficiency slows down its users from completion of the intended task as fast as possible.

Finally, existing POS or kiosk-based solutions label each order entry button or demonstrate the purpose of each order entry button using a static icon and text caption. Often times, the icon and/or text caption cannot always represent the true purpose of the button. As a result, users usually ignore the icon and instead read the text caption on the button, which slows down user operation. Existing solutions are inefficient in their handling of button information display, when clarity of purpose is needed. Order entry buttons, such as Order Type, Payment Type, Menu Group, Menu Item, Menu Modifier, Discount, Surcharge, and Seating Objects are all critical action buttons that need to convey a clear understanding to its users so that its users do not mistake the intended click for something else.

A faster and better approach to the existing point of sale/service (POS) or kiosk-based solutions for computerized order entry item information access is needed so users can quickly and efficiently access item information to confirm details before adding an item to the order.

### SUMMARY

In various example embodiments, systems and methods for efficient navigation of an order entry system user interface are disclosed. In various embodiments, a software application program is used to enable the development, processing, and presentation of a user interface to improve the operation and efficiency of a user interface for POS and order entry devices. In a computerized order entry system, where a touch screen, or other display device in combination with a touch input device, is utilized for its users to order items and query item information, a fast and efficient way to query item information is a necessity in a fast-paced retail, hospitality, or kiosk environment. Any inefficient or slow workflow on the part of item information query access will result in delayed processing, or worse, wrong items being ordered, resulting in losses and customer dissatisfaction.

In a first example embodiment of a computerized order entry system, where a touch screen is utilized for its users to order items and invoke related actions, a system and method is disclosed for providing a minimal user input mechanism to enable the user to expand an on-screen interactive order display region to a full screen view and back to a collapsed view with minimal user inputs, in most cases, a single user input. Embodiments include a landscape display mode and/or a portrait display mode orientation.

In a second example embodiment of a computerized order entry system, a system and method is disclosed for enabling the user to use two fingers together to tap (e.g., Double Finger Tap) on any one of the user input objects provided within a user input region. As a result of this Double Finger Tap, a pop-up information display region or Item Information Detail Screen is presented. The pop-up information display region or Item Information Detail Screen can be used to provide a detailed explanation of the usage and effect of the corresponding button or user input object.

In a third example embodiment of a computerized order entry system, where a touch screen is utilized for its users to order items and invoke related actions, having a fast and efficient way to invoke such actions is crucial for user productivity and accuracy. A fast-paced environment such as retail, hospitality, or kiosk environment excels on productive and efficient operating workflow. Any inefficient or slow workflow on the part of button action invocation will result in delayed processing, errant ordering, unnecessary losses, and customer dissatisfaction. In various example embodiments described herein, a faster approach is disclosed to improve button action invocation on the order entry screen via gesture-based operations. Using the disclosed solution, rather than looking for the actual button located on the order entry screen, the user can use one or more fingers to compose a gesture and complete the task in a very fast manner. The user will no longer have to hunt down and click the action button each time. The disclosed embodiments save countless amounts of time and improve user efficiency.

In a fourth example embodiment of a computerized order entry system, where a touch screen is utilized for its users to order items and pay orders, it is important to provide the ability to clearly convey the purpose of each button in a description of the underlying button functionality. Clarity of button description is a crucial necessity in a fast-paced retail, hospitality, or kiosk environment. Any misunderstanding or misrepresentation of the purpose of the button will result in delayed processing, errant item ordering or action invocation, resulting in losses and customer dissatisfaction. In an example embodiment disclosed herein, a more clear presentation of the button purpose is provided by a solution only needing low levels of system resources. In the example embodiment, buttons may have an associated motion image or graphical moving picture to demonstrate the purpose of the button. The button textual caption may continue to be present. An example embodiment uses a single picture supporting motion (such as a Graphics Interchange Format—GIF) to describe each button. As a result, system resources are not overly taxed compared with embedded videos for dozens of buttons, or URL-linked videos that must be downloaded each time, thus causing a slow system and user experience. Multi-picture buttons are also avoided as they tax system resources more heavily.

In the various example embodiments described herein, a computer-implemented tool or software application (app) as part of a point-of-sale processing system is described to provide order entry and point-of-sale transaction processing. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

### BRIEF DESCRIPTION OF THE DRAWINGS

The various embodiments are illustrated by way of example, and not by way of limitation, in the figures of the accompanying drawings in which:

FIGS. 1 through 3 illustrate examples of conventional order entry presentations on the user interfaces of typical point-of-sale/service (POS) or kiosk-based devices;

FIG. 4 illustrates a block diagram of an example embodiment of a networked system in which various embodiments may operate;

FIG. 5 illustrates a block diagram of an example embodiment of a point-of-sale/service (POS) or kiosk-based device in which various embodiments may operate;

FIGS. 6 through 14 illustrate various example user interface screen snapshots, implemented on a point-of-sale/service (POS) or kiosk-based device, that show the various elements of the user interface for displaying order entry information and receiving user inputs associated with the order entry system in an example embodiment; and

FIG. 15 illustrates a processing flow diagram that illustrates an example embodiment of a method as described herein.

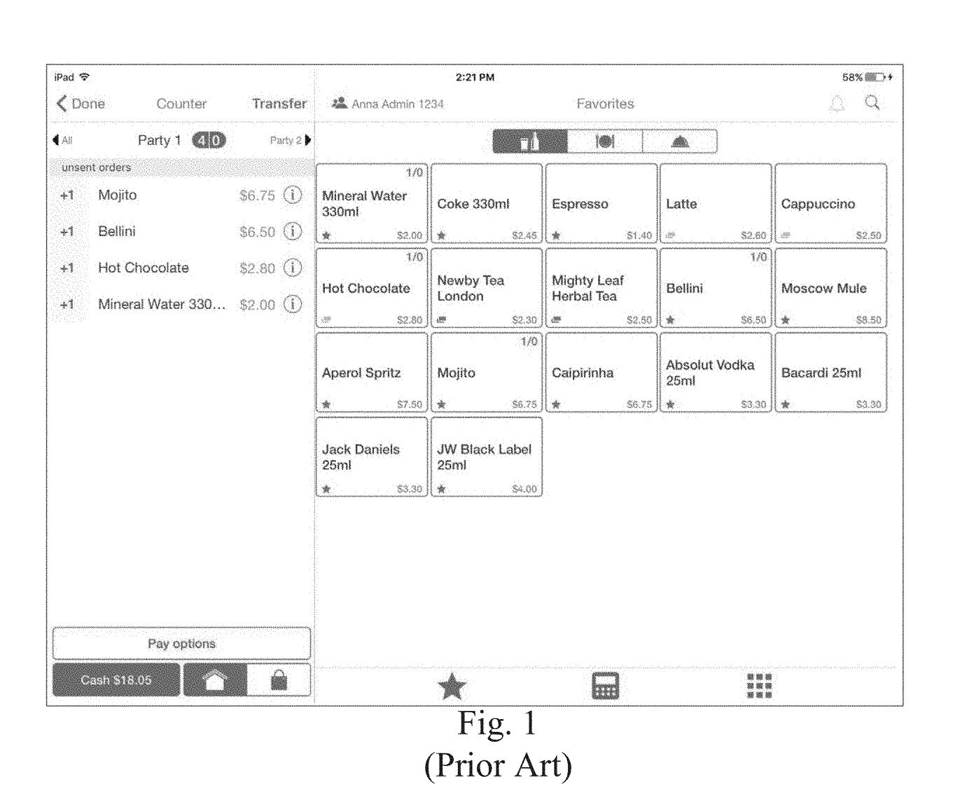

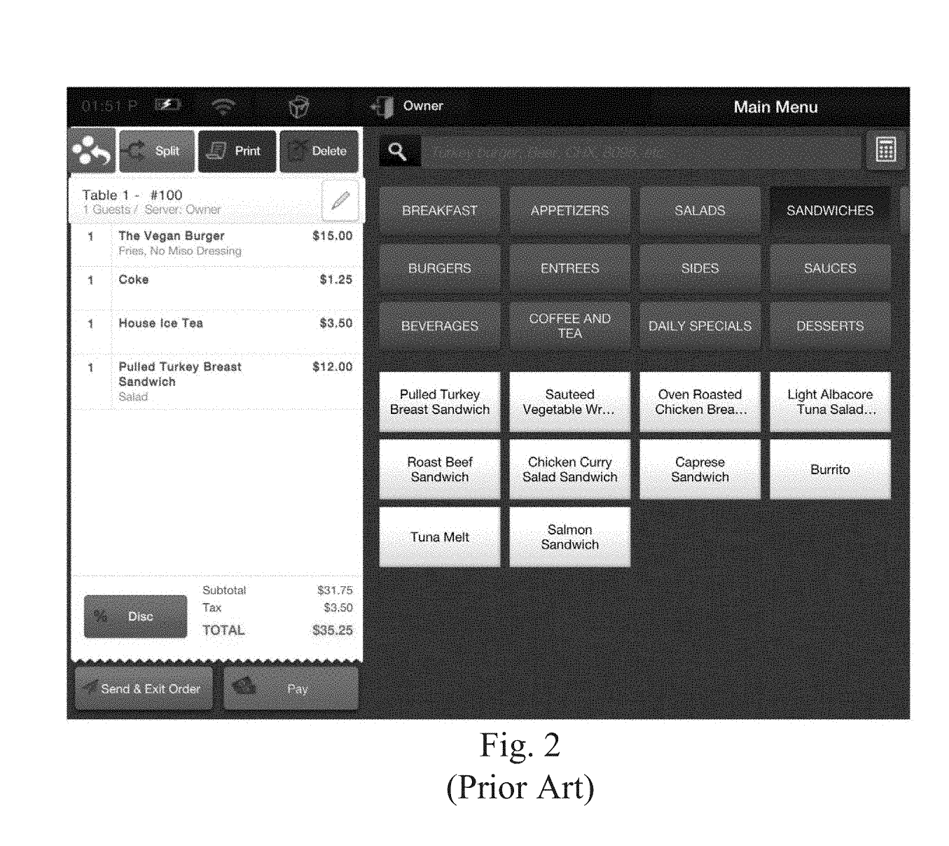

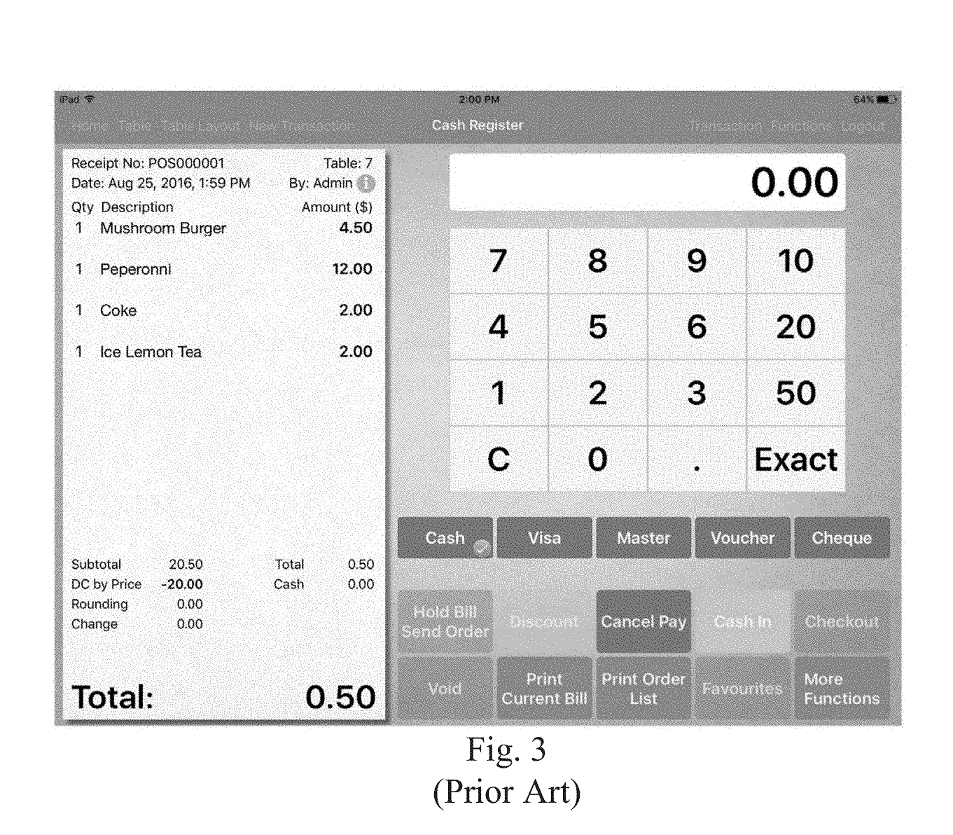

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

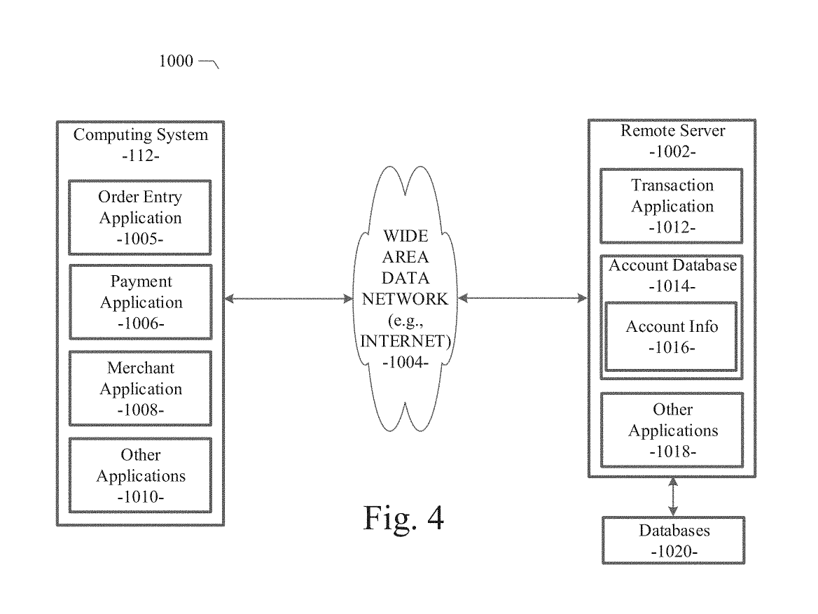

FIG. 4 is a block diagram of a networked system 1000, consistent with example embodiments. System 1000 includes a computing device 112 and a remote server 1002 in communication over a network 1004. Remote server 1002 may be a remote order processing, transaction processing, or payment processing service provider server that may be maintained by a local merchant or third party service provider. Remote server 1002 may be maintained by various service providers in different embodiments. Remote server 1002 may also be maintained by an entity with which sensitive credentials and information may be exchanged with computing system 112. Remote server 1002 may be more generally a web site, an online service manager, a merchant site, a service provider, such as a bank, or other entity who provides various types of order entry support, service transaction support, or payment support to a user at a merchant location.

Network 1004, in one embodiment, may be implemented as a single network or a combination of multiple networks. For example, in various embodiments, network 1004 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

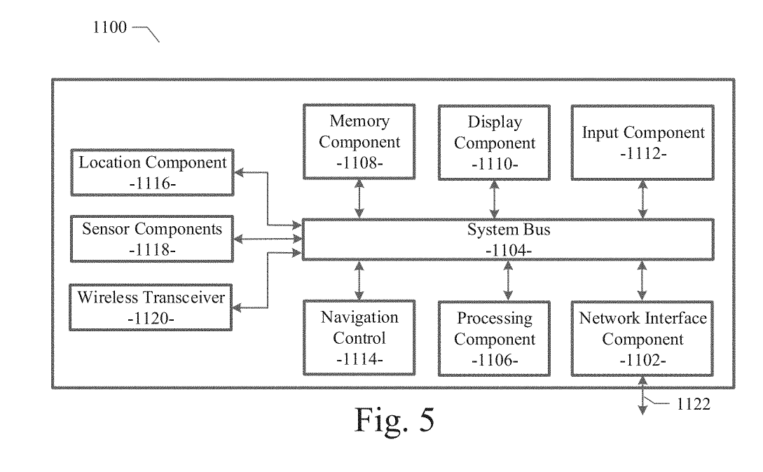

Computing device 112, in one embodiment, may be implemented using any appropriate combination of hardware and/or software configured for wired and/or wireless communication over network 1004. In particular, computing device 112 may be a point-of-sale/service (POS) or kiosk-based device, smartphone or tablet computer, such as described in more detail in FIG. 5. Consistent with example embodiments, computing device 112 may include any appropriate combination of hardware and/or software having one or more processors and capable of reading instructions stored on a tangible non-transitory machine-readable medium for execution by the one or more processors. Consistent with example embodiments, computing device 112 includes a machine-readable medium, such as a memory (shown in FIG. 5) that includes instructions for execution by one or more processors (shown in FIG. 5) for causing computing device 112 to perform specific tasks. For example, such instructions may include an order entry application 1005 or a payment application 1006 that may allow a merchant or customer to use computing device 112 to order items or services and to authorize a payment. In example embodiments, order entry application 1005 and/or payment application 1006 may be configured to include a POS user interface processing module to generate, present, render, process, and manage the user interfaces and user interface functionality as described herein. In example embodiments, order entry application 1005 and/or payment application 1006 may be configured to interface with remote server 1002 over network 1004 to process ordered items and to authorize payments processed by remote server 1002.

Computing device 112 may also include one or more merchant applications 1008. In example embodiments, merchant applications 1008 may be applications that allow a merchant or buyer to use computing device 112 in a POS system. Merchant applications 1008 may include any applications that allow a merchant or customer to, order goods/services, scan goods and/or services (collectively referred to as items or products) to create a bill of sale or invoice, and then effect payment for the items using payment application 1006 and/or a card reader (not shown) or other known payment mechanism. Merchant applications 1008 may allow a merchant to accept various credit, gift, or debit cards, cash, or payment processing service providers, such as may be provided by remote server 1002, for payment for items.

Computing device 112 may include other applications 1010 as may be desired in one or more embodiments to provide additional features available. For example, applications 1010 may include interfaces and communication protocols that allow a merchant or customer receive and transmit information through network 1004 and to remote server 1002 and other online sites. Applications 1010 may also include security applications for implementing client-side security features, programmatic client applications for interfacing with appropriate application programming interfaces (APIs) over network 1004 or various other types of generally known programs and/or applications. Applications 1010 may include mobile applications downloaded and resident on computing device 112 that enables merchants and customers to access content through applications 1010.

Remote server 1002, according to example embodiments, may be maintained by an online order entry processing service or payment processing provider, which may provide processing for point-of-sale transactions, order entry transactions, or online financial and payment transactions on behalf of users including merchants and customers. Remote server 1002 may include at least transaction application 1012, which may be configured to interact with order entry application 1005 and merchant applications 1008 of computing device 112 over network 1004 to receive and process transactions. Remote server 1002 may also include an account database 1014 that includes account information 1016 for users having an account on remote server 1002, such as a customer or merchant. In example embodiments, transaction application 1012 may store and retrieve point-of-sale transaction information, order entry transaction information, and/or financial information in account information 1016 of account database 1014. Remote server 1002 may include other applications 1018, such as may be provided for authenticating users to remote server 1002, for performing financial transactions, and for processing payments. Remote server 1002 may also be in communication with one or more external databases 1020, which may provide additional information that may be used by remote server 1002. In example embodiments, databases 1020 may be databases maintained by third parties, and may include third party financial information of merchants and customers.

Although discussion has been made of applications and applications on computing device 112 and remote server 1002, the applications may also be, in example embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the described applications.

FIG. 5 illustrates a computing system 1100, which may correspond to either of client computing device 112 or remote server 1002, consistent with example embodiments. Computing system 1100 may be a point-of-sale/service (POS) or kiosk-based device, a mobile device such as a smartphone, a tablet computer, and the like as would be consistent with computing device 112. Further, computing system 1100 may also be a server or one server amongst a plurality of servers, as would be consistent with remote server 1002. As shown in FIG. 5, computing system 1100 includes a network interface component (NIC) 1102 configured for communication with a network such as network 1004 shown in FIG. 4. Consistent with example embodiments, NIC 1102 can include a wireless communication component, such as a wireless broadband component, a wireless satellite component, or various other types of wireless communication components including radio frequency (RF), microwave frequency (MWF), and/or infrared (IR) components configured for communication with network 1004. Consistent with other embodiments, NIC 1102 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 1004.

Consistent with example embodiments, computing system 1100 includes a system bus 1104 for interconnecting various components within computing system 1100 and communicating information between the various components. Such components include a processing component 1106, which may be one or more processors, micro-controllers, graphics processing units (GPUs) or digital signal processors (DSPs), and a memory component 1108, which may correspond to a random access memory (RAM), an internal memory component, a read-only memory (ROM), or an external or static optical, magnetic, or solid-state memory. Consistent with example embodiments, computing system 1100 further includes a display component 1110 for displaying information to a user of computing system 1100. Display component 1110 may be a liquid crystal display (LCD) screen, an organic light emitting diode (OLED) screen (including active matrix AMOLED screens), an LED screen, a plasma display, or a cathode ray tube (CRT) display. Computing system 1100 may also include an input component 1112, allowing for a user of computing system 1100, to input information to computing system 1100. Such information could include order entry information or payment information such as an amount required to complete a transaction, account information, authentication information such as a credential, or identification information. An input component 1112 may include, for example, a keyboard or key pad, whether physical or virtual. Input component 1112 may also be implemented as a touch input device or a touchscreen display device. Computing system 1100 may further include a navigation control component 1114, configured to allow a user to navigate along display component 1110. Consistent with example embodiments, navigation control component 1114 may be a mouse, a trackball, stylus, or other such device. Moreover, if device 1100 includes a touchscreen, display component 1110, input component 1112, and navigation control 1114 may be a single integrated component, such as a capacitive sensor-based touch screen.

Computing system 1100 may further include a location component 1116 for determining a location of computing system 1100. In example embodiments, location component 1116 may correspond to a Global Positioning System (GPS) transceiver that is in communication with one or more GPS satellites. In other embodiments, location component 1116 may be configured to determine a location of computing system 1100 by using an internet protocol (IP) address lookup, or by triangulating a position based on nearby telecommunications towers, wireless access points (WAPs), or BLE beacons. Location component 1116 may be further configured to store a user-defined location in memory component 1108 that can be transmitted to a third party for the purpose of identifying a location of computing system 1100. Computing system 1100 may also include sensor components 1118. Sensor components 1118 provide sensor functionality, and may correspond to sensors built into, for example, computing device 112 or sensor peripherals coupled to computing device 112. Sensor components 1118 may include any sensory device that captures information related to computing device 112 or a merchant or customer using computing device 112 and any actions performed using computing device 112. Sensor components 1118 may include camera and imaging components, accelerometers, biometric readers, GPS devices, motion capture devices, and other devices. Computing system 1100 may also include one or more wireless transceivers 1120 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, Bluetooth®, BLE, WiMAX, ZigBee®, etc. With respect to computing device 112, wireless transceiver 1120 may include a BLE beacon, an NFC module, and a Wi-Fi router.

Computing system 1100 may perform specific operations by processing component 1106 executing one or more sequences of instructions contained in memory component 1108. In other embodiments, hard-wired circuitry may be used in place of or in combination with software instructions to implement embodiments of the present disclosure. Logic may be encoded in a computer readable medium, which may refer to any medium that participates in providing instructions to processing component 1106 for execution, including memory component 1108. Consistent with example embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 1104. According to example embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 1100. In various other embodiments of the present disclosure, a plurality of computing systems 1100 coupled by a communication link 1122 to network 1004 (e.g., such as the Internet, a LAN, WLAN, PTSN, and/or various other wired or wireless networks, including telecommunications, mobile, and cellular phone networks) may perform instruction sequences to practice the present disclosure in coordination with one another. Computing system 1100 may transmit and receive messages, data and one or more data packets, information and instructions, including one or more programs (i.e., application code) through communication link 1122 and network interface component 1102 and/or wireless transceiver 1120. Received program code may be executed by processing component 1106 as received and/or stored in memory component 1108.

Computing system 1100 may include more or less components than shown in FIG. 5 according to example embodiments. Moreover, components shown in FIG. 5 may be directly coupled to one or more other components in FIG. 5, eliminating a need for system bus 1104. Furthermore, components shown in FIG. 5 may be shown as being part of a unitary system 1100, but may also be part of a distributed system where the components are separate but coupled and in communication. In general, the components shown in FIG. 5 are shown as examples of components in a computing system 1100 capable of performing embodiments disclosed herein. However, a processing system 1100 may have more or fewer components and still be capable of performing example embodiments disclosed herein.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

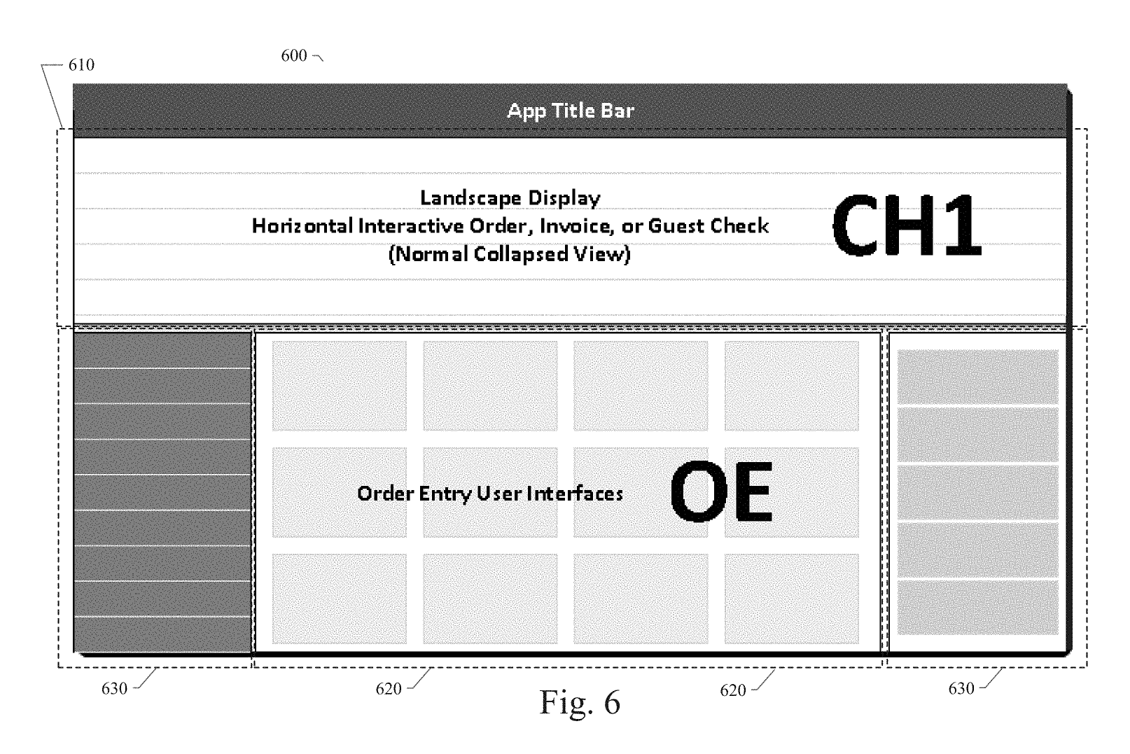

FIGS. 6 through 14 illustrate various example user interface screen snapshots of a user interface implemented on a point-of-sale/service (POS), a kiosk-based device, or other device such as computing device 112 or 1100, wherein the screen snapshots show the basic elements of the user interface for displaying data and receiving user inputs associated with an order entry system in an example embodiment. In the various example embodiments described below, four basic variations of the disclosed embodiments are described in detail. Each of the four example embodiments serve to improve user efficiency and speed when using order entry functionality on a POS device. These four example embodiments are described in detail below.

### Example Embodiment 1

Referring now to FIG. 6, a diagram illustrates an example user interface screen snapshot of a user interface 600 implemented on a point-of-sale/service (POS), a kiosk-based device, or other device, such as computing device 112 or 1100. In such an example of a computerized order entry system, where a touch screen is utilized for its users to interface for the purpose of inputting and managing orders, the user interface 600 can be configured to include several regions, which serve specific purposes. For example as shown in FIG. 6, a horizontally-rendered on-screen interactive order display region 610 (e.g., invoice or guest check highlighted with a dashed rectangle) is where the user can review and edit what has already been ordered for accuracy and completeness. In this example, the on-screen interactive order display region 610 is horizontally rendered at the top of the display and extending to each side of the display. The order entry region 620 (highlighted with a dashed rectangle) of user interface 600 represents a typical arrangement of buttons, icons, or other user input objects with which the user can select ordered items. The ordered items selected via order entry region 620 typically show up in the on-screen interactive order display region 610 as a running list of ordered items. The ancillary user input regions 630 (highlighted with dashed rectangles) of user interface 600 represent typical arrangements of other buttons, icons, other user input objects, or other information display areas with which the user can select, view, or edit a variety of other functions or options available for a particular application or location in which the point-of-sale/service (POS), kiosk-based device, or other device, such as computing device 112 or 1100, is used.

In the example shown in FIG. 6, the on-screen interactive order display region 610 is arranged in a horizontal or landscape configuration in a normally collapsed view where each of the other regions of the user interface 600 are visible. In this normally collapsed view, only a portion of the content of the on-screen interactive order display region 610 is typically visible to the user. In a fast-paced retail, hospitality, or kiosk environment, it is extremely important for the computerized order entry system to allow its users to quickly and easily review the entire order placed, make any changes/additions, and confirm order accuracy before submitting the complete order for processing. Any inefficient or slow workflow on the part of the on-screen order access will result in delayed processing, or worse, wrong orders being submitted, resulting in losses and customer dissatisfaction. Because the on-screen interactive order display region 610 is typically in a collapsed view, the user must manipulate at least two or more inputs or button activations on a conventional POS device to expand the on-screen interactive order display region 610 to a full screen view to enable the user to view the entire order. This conventional user interface functionality is inefficient and does not allow its users to quickly and easily review the entire order placed.

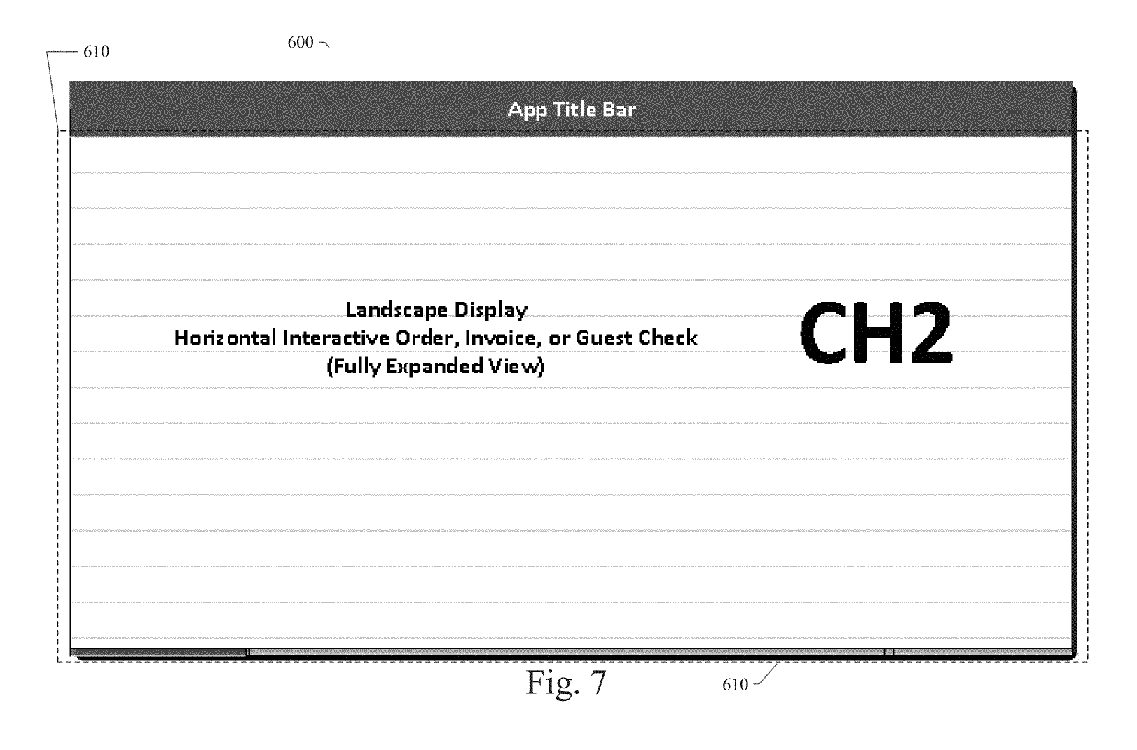

In contrast to the existing user interface implementations, the embodiments disclosed herein provide a minimal user input mechanism to enable the user to expand the on-screen interactive order display region 610 to a full screen view and back to a collapsed view with minimal user inputs, in most cases, a single user input. An embodiment of the full screen landscape view of the on-screen interactive order display region 610 is shown in FIG. 7. As shown in FIGS. 6 and 7 for an example embodiment, the on-screen interactive order display region 610 (see FIG. 6) can be expanded into a full screen landscape mode (see FIG. 7) either via a single button click, via a single finger swipe with two or more fingers, via a single finger tap with two or more fingers, or rotation of the computing device from a landscape display mode or orientation to portrait display mode or orientation. As such, the user can manipulate a single input or button activation on the POS device to expand the on-screen interactive order display region 610 to a full screen landscape view to enable the user to view the entire order. In a full screen view, the on-screen interactive order display region 610 may obscure other regions of the user interface 600.

To return the full screen landscape expanded on-screen interactive order display region 610 (see FIG. 7) to a normally collapsed view (see FIG. 6), the user can apply another single input, such as a single button click, a single finger swipe with two or more fingers, a single finger tap with two or more fingers, or rotation of the computing device from a portrait display mode to a landscape display mode. As a result of one of these single input activations, the on-screen interactive order display region 610 automatically collapses into a normal collapsed view as shown in FIG. 6. In a normal collapsed view, the on-screen interactive order display region 610 does not typically obscure other regions of the user interface 600.

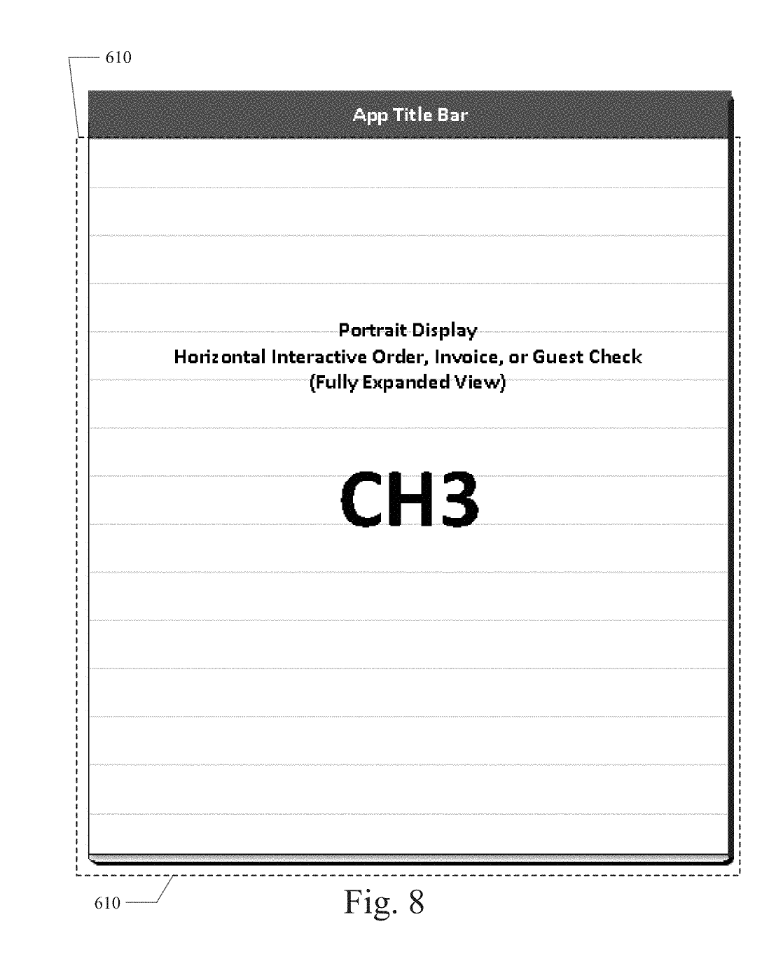

In an alternative embodiment, the full screen view of the on-screen interactive order display region 610 can be a full screen portrait view as shown in FIG. 8. As shown in FIGS. 6 and 8 for an example embodiment, the on-screen interactive order display region 610 (see FIG. 6) can be expanded into a full screen portrait mode (see FIG. 8) either via a single button click, via a single finger swipe with two or more fingers, via a single finger tap with two or more fingers, or rotation of the computing device from a landscape display mode to portrait display mode. As such, the user can manipulate a single input or button activation on the POS device to expand the on-screen interactive order display region 610 to a full screen portrait view to enable the user to view the entire order. In a full screen view, the on-screen interactive order display region 610 may obscure other regions of the user interface 600.

To return the full screen portrait expanded on-screen interactive order display region 610 (see FIG. 8) to a normally collapsed view (see FIG. 6), the user can apply another single input, such as a single button click, a single finger swipe with two or more fingers, a single finger tap with two or more fingers, or rotation of the computing device from a portrait display mode to a landscape display mode. As a result of one of these single input activations, the on-screen interactive order display region 610 automatically collapses into a normal collapsed view as shown in FIG. 6. In a normal collapsed view, the on-screen interactive order display region 610 does not typically obscure other regions of the user interface 600.

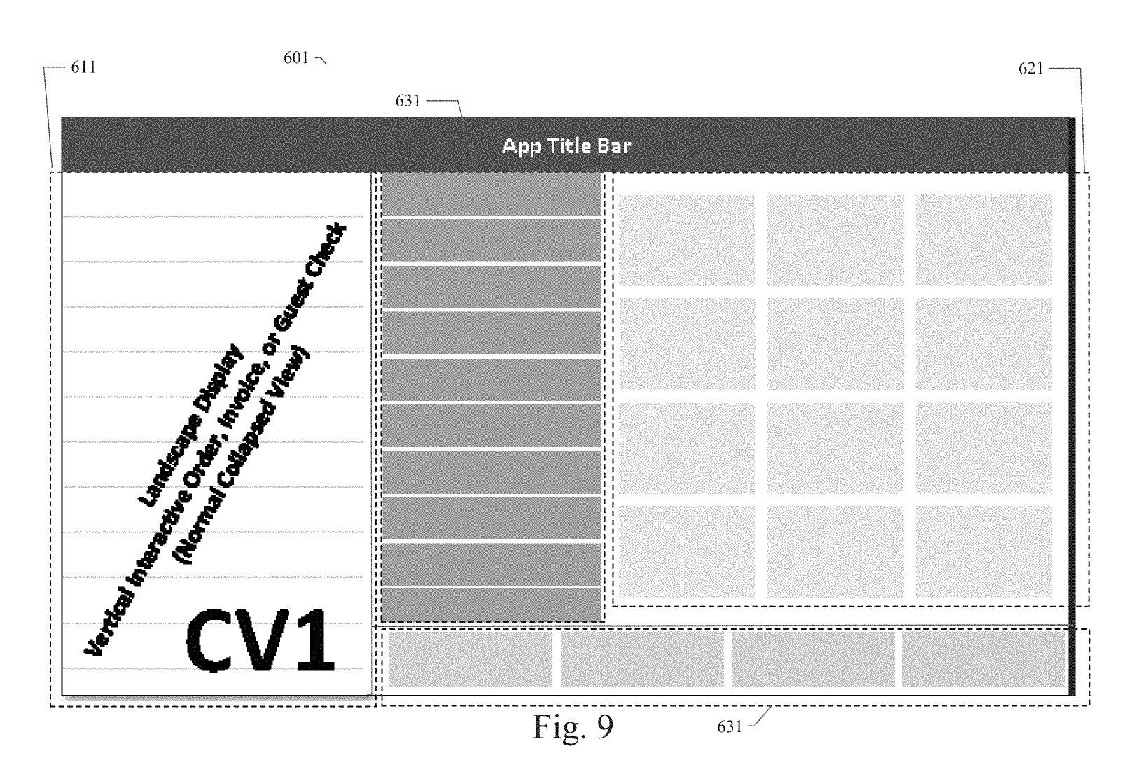

Referring now to FIG. 9, a diagram illustrates an example user interface screen snapshot of a user interface 601 implemented on a point-of-sale/service (POS), a kiosk-based device, or other device, such as computing device 112 or 1100. In such an example of a computerized order entry system, where a touch screen is utilized for its users to interface for the purpose of inputting and managing orders, the user interface 601 can be configured to include several regions, which serve specific purposes. For example as shown in FIG. 9, a vertically-rendered on-screen interactive order display region 611 (e.g., invoice or guest check highlighted with a dashed rectangle) is where the user can review and edit what has already been ordered for accuracy and completeness. In this example, the on-screen interactive order display region 611 is vertically rendered on a side of the display and extending to the top and bottom of the display. The order entry region 621 (highlighted with a dashed rectangle) of user interface 601 represents a typical arrangement of buttons, icons, or other user input objects with which the user can select ordered items. The ordered items selected via order entry region 621 typically show up in the on-screen interactive order display region 611 as a running list of ordered items. The ancillary user input regions 631 (highlighted with dashed rectangles) of user interface 601 represent typical arrangements of other buttons, icons, other user input objects, or other information display areas with which the user can select, view, or edit a variety of other functions or options available for a particular application or location in which the point-of-sale/service (POS), kiosk-based device, or other device, such as computing device 112 or 1100, is used.

In the example shown in FIG. 9, the on-screen interactive order display region 611 is arranged in a vertical or portrait configuration in a normally collapsed view where each of the other regions of the user interface 601 are visible. In this normally collapsed view, only a portion of the content of the on-screen interactive order display region 611 is typically visible to the user. Because the on-screen interactive order display region 611 is typically in a collapsed view, the user must manipulate at least two or more inputs or button activations on a conventional POS device to expand the on-screen interactive order display region 611 to a full screen view to enable the user to view the entire order. This conventional user interface functionality is inefficient and does not allow its users to quickly and easily review the entire order placed.

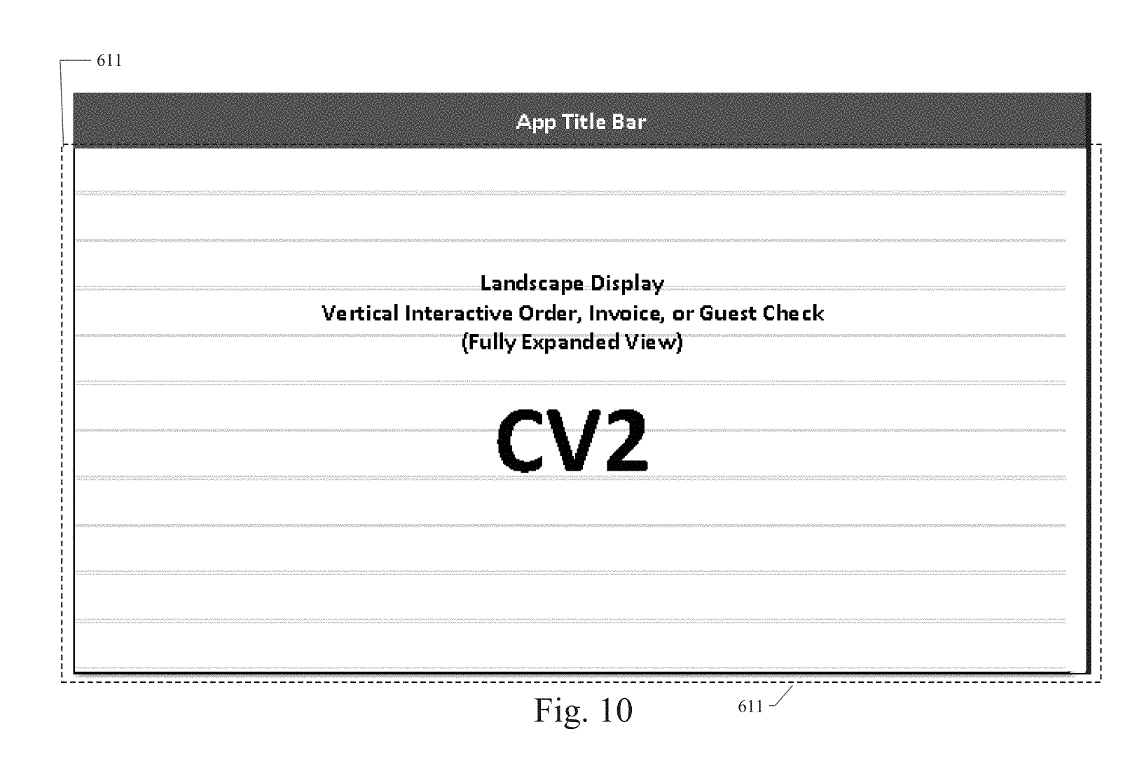

In contrast to the existing user interface implementations, the embodiments disclosed herein provide a minimal user input mechanism to enable the user to expand the on-screen interactive order display region 611 to a full screen view and back to a collapsed view with minimal user inputs, in most cases, a single user input. An embodiment of the full screen landscape view of the on-screen interactive order display region 611 is shown in FIG. 10. As shown in FIGS. 9 and 10 for an example embodiment, the on-screen interactive order display region 611 (see FIG. 9) can be expanded into a full screen landscape mode (see FIG. 10) either via a single button click, via a single finger swipe with two or more fingers, via a single finger tap with two or more fingers, or rotation of the computing device from a landscape display mode to portrait display mode. As such, the user can manipulate a single input or button activation on the POS device to expand the on-screen interactive order display region 611 to a full screen landscape view to enable the user to view the entire order. In a full screen view, the on-screen interactive order display region 611 may obscure other regions of the user interface 601.

To return the full screen landscape expanded on-screen interactive order display region 611 (see FIG. 10) to a normally collapsed view (see FIG. 9), the user can apply another single input, such as a single button click, a single finger swipe with two or more fingers, a single finger tap with two or more fingers, or rotation of the computing device from a portrait display mode to a landscape display mode. As a result of one of these single input activations, the on-screen interactive order display region 611 automatically collapses into a normal collapsed view as shown in FIG. 9. In a normal collapsed view, the on-screen interactive order display region 611 does not typically obscure other regions of the user interface 601.

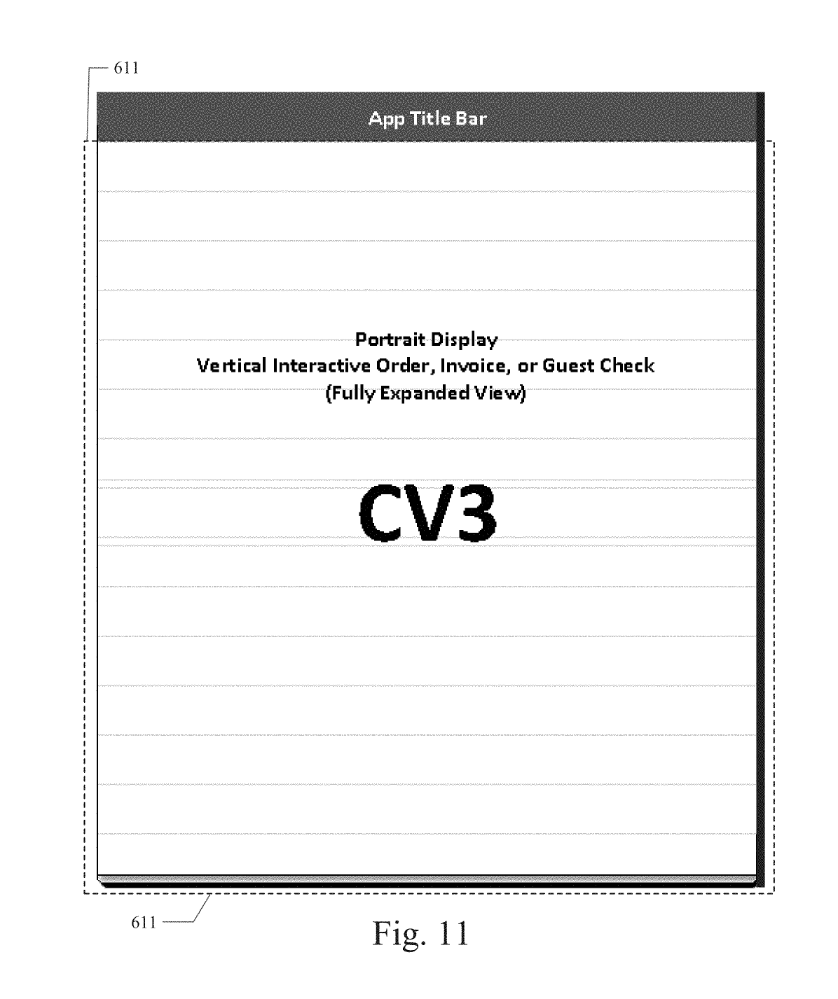

In an alternative embodiment, the full screen view of the on-screen interactive order display region 611 can be a full screen portrait view as shown in FIG. 11. As shown in FIGS. 9 and 11 for an example embodiment, the on-screen interactive order display region 611 (see FIG. 9) can be expanded into a full screen portrait mode (see FIG. 11) either via a single button click, via a single finger swipe with two or more fingers, via a single finger tap with two or more fingers, or rotation of the computing device from a landscape display mode to portrait display mode. As such, the user can manipulate a single input or button activation on the POS device to expand the on-screen interactive order display region 611 to a full screen portrait view to enable the user to view the entire order. In a full screen view, the on-screen interactive order display region 611 may obscure other regions of the user interface 601.

To return the full screen portrait expanded on-screen interactive order display region 611 (see FIG. 11) to a normally collapsed view (see FIG. 9), the user can apply another single input, such as a single button click, a single finger swipe with two or more fingers, a single finger tap with two or more fingers, or rotation of the computing device from a portrait display mode to a landscape display mode. As a result of one of these single input activations, the on-screen interactive order display region 611 automatically collapses into a normal collapsed view as shown in FIG. 9. In a normal collapsed view, the on-screen interactive order display region 611 does not typically obscure other regions of the user interface 601.

These example embodiments enable the computerized order entry users to quickly and effortlessly access a full screen order to review and edit, and quickly return the view to a normal collapsed view. The pure simplicity of this approach enables its users faster activity completions and a simpler interface with the ordering system, ensuring more productivity and efficiency overall. This example embodiment also accomplishes several objectives including: 1) allowing users to access the full screen of the touch screen display for on-screen order access, providing a way to review and edit orders in a faster and more efficient manner; 2) providing a very fast and simple way to switch between the normally collapsed view of the on-screen order and the fully expanded full screen rendering of the on-screen order with minimal effort on the part of its users; and 3) ensuring that these embodiments support both on-screen orders normally displayed horizontally (landscape) or vertically (portrait), occupying a portion of the touch screen display when under a normal view.

In the described example embodiment, the computing device can be a point-of-sale/service (POS), kiosk-based device, or other device, such as computing device 112 or 1100, The computing device can be a computer or tablet with a touch display, whether multi-touch or not. The computing device can be executing an order entry application, which includes the user interface functionality as described herein. The order entry application can be accessible on the computing device, regardless if the application is natively installed or accessible via a remote desktop, web browser or otherwise.

### Example Embodiment 2

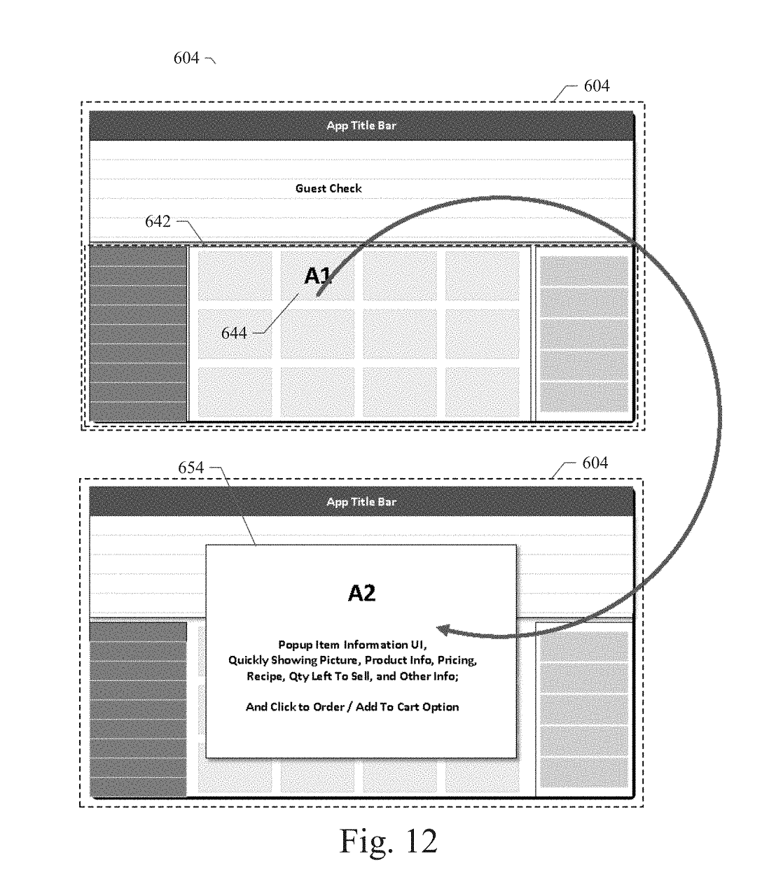

Referring now to FIG. 12, a diagram illustrates an example user interface screen snapshot of a user interface 604 implemented on a point-of-sale/service (POS), a kiosk-based device, or other device, such as computing device 112 or 1100. In such an example of a computerized order entry system, where a touch screen is utilized for its users to interface for the purpose of inputting and managing orders, the user interface 604 can be configured to include several regions, which serve specific purposes. For example as shown in FIG. 12, a user input region 642 (highlighted with a dashed rectangle) of user interface 604 represents a typical arrangement of buttons, icons, or other user input objects with which the user can select ordered items or select, view, or edit a variety of other functions or options available for a particular application or location in which the point-of-sale/service (POS), kiosk-based device, or other device, such as computing device 112 or 1100 is used. In the example shown in FIG. 12, button 644 is one example of the user input objects provided within user input region 642. Typically, to order a particular item or activate a particular function, the user uses a single finger to tap (e.g., Single Finger Tap) one of the user input objects of user input region 642 corresponding to the desired item or function.

However, in many cases, the user is not sure which button to tap to order or activate the desired item or function. Often, because of the large quantity of buttons provided in user input region 642 and the relatively small size of the display device, the information identifying the items or functions corresponding to each button may be highly abbreviated or rendered in a small font. In any case, the user may be confused by the image, wording, or information provided for each button. As a result, the user may order the wrong item or activate an unwanted function, thereby causing delays and inefficiency. In other conventional POS user interfaces, the user may have an option to view additional information on the available items or functions; but, the additional information can only be accessed after multiple, time-consuming user inputs.

In a solution to this problem with conventional POS user interfaces, a second example embodiment is provided herein. In this example embodiment, the user interface 604 enables the user to use two fingers together to tap (e.g., Double Finger Tap) on any one of the user input objects (e.g., button 644) provided within user input region 642. As a result of this Double Finger Tap, a pop-up information display region or Item Information Detail Screen 654 is presented as shown in FIG. 12. The pop-up information display region or Item Information Detail Screen 654 can be used to provide a detailed explanation of the usage and effect of the corresponding button or user input object. In this manner, the user does not need to use two or more steps to achieve the end goal, or click on a tiny icon somewhere in the item button. Also, this embodiment allows the user to quickly call up the item information before the item is ordered or the function is invoked.

Referring again to FIG. 12, the user can use a Single Finger Tap to order an item or activate a function corresponding to one of the buttons (e.g., button 644) provided within user input region 642. However, if the user needs to view information related to a particular button (e.g., button 644) provided within user input region 642 prior to actually ordering an item or activating the function corresponding to the button, the user can use a Double Finger Tap on the button for which more information is needed. As a result, the pop-up information display region or Item Information Detail Screen 654 is presented as shown in FIG. 12 to inform the user on the details of the corresponding button. For example, the details provided in the pop-up information display region or Item Information Detail Screen 654 could include, for example, product or item name, prices, pictures, recipes, quantity left to sell, related products/items, inventory information, warnings, etc. When the user is finished with the pop-up information display region or Item Information Detail Screen 654, the user can simply tap the pop-up information display region or Item Information Detail Screen 654 to dismiss the screen 654 and the screen 654 is automatically removed. Then, the user can again use a Single Finger Tap to order a desired item or invoke a desired function using one of the buttons provided within user input region 642.

This embodiment enables the computerized order entry users to quickly and effortlessly access Item Information Details via a Double Finger Tap on the item button. This approach enables its users to accomplish faster activity completions with a simpler user interface of the ordering system, ensuring more productivity and efficiency overall.

In the described example embodiment, the computing device can be a point-of-sale/service (POS), kiosk-based device, or other device, such as computing device 112 or 1100, The computing device can be a computer or tablet with a touch display, whether multi-touch or not. The computing device can be executing an order entry application, which includes the user interface functionality as described herein. The order entry application can be accessible on the computing device, regardless if the application is natively installed or accessible via a remote desktop, web browser or otherwise.

### Example Embodiment 3

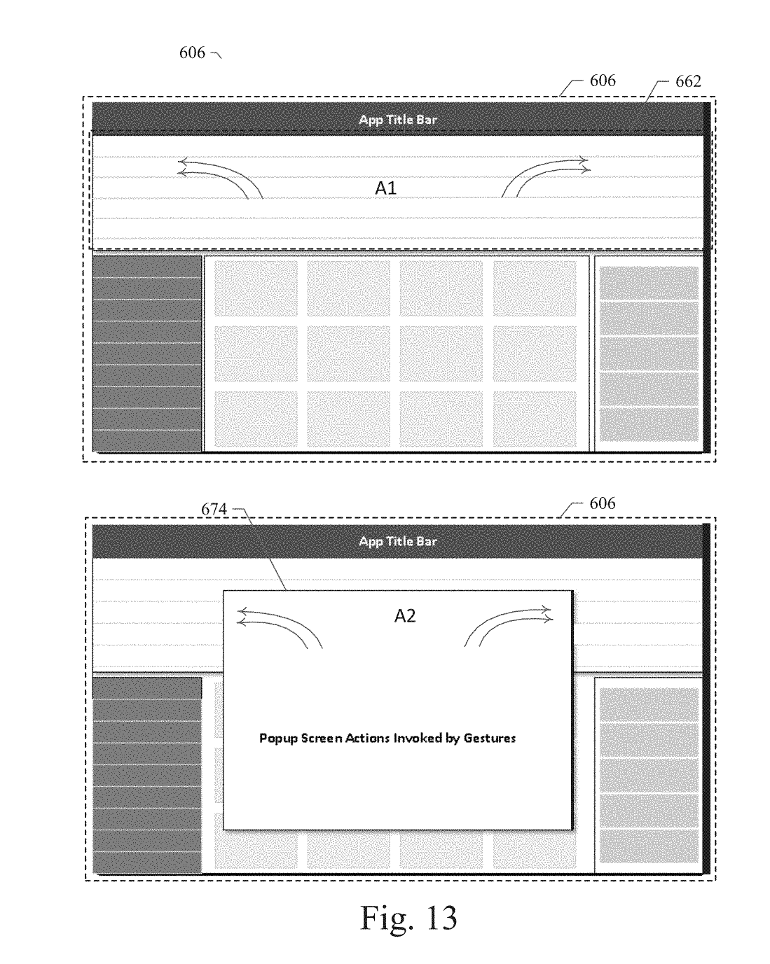

Referring now to FIG. 13, a diagram illustrates an example user interface screen snapshot of a user interface 606 implemented on a point-of-sale/service (POS), a kiosk-based device, or other device, such as computing device 112 or 1100. In such an example of a computerized order entry system, where a touch screen is utilized for its users to interface for the purpose of inputting and managing orders, the user interface 606 can be configured to include several regions, which serve specific purposes. For example as shown in FIG. 13, a horizontally-rendered on-screen interactive order display region 662 (e.g., invoice or guest check highlighted with a dashed rectangle) is where the user can review and edit what has already been ordered for accuracy and completeness. In this example, the on-screen interactive order display region 662 is horizontally rendered at the top of the display and extending to each side of the display. In an alternative embodiment, the on-screen interactive order display region 662 can be vertically rendered on a side of the display and extending to the top and bottom of the display. In the example shown in FIG. 13, the on-screen interactive order display region 662 is arranged in a horizontal or landscape configuration in a normally collapsed view where each of the other regions of the user interface 606 are visible. In this normally collapsed view, only a portion of the content of the on-screen interactive order display region 662 is typically visible to the user. In a fast-paced retail, hospitality, or kiosk environment, it is extremely important for the computerized order entry system to allow its users to quickly and easily review the entire order placed, make any changes/additions, and confirm order accuracy before submitting the complete order for processing and payment. Any inefficient or slow workflow on the part of the on-screen order access will result in delayed processing and customer dissatisfaction. In conventional POS systems, the user must manipulate at least two or more inputs or button activations on a typical POS device to complete an order or to submit the order for payment. This conventional user interface functionality is inefficient and does not allow its users to quickly and easily complete an order and submit the order for payment.

In contrast to the existing user interface implementations, the embodiments disclosed herein provide a minimal user input mechanism to enable the user to complete an order and submit the order for payment. As shown in FIG. 13 for an example embodiment, the user can use a gesture within the on-screen interactive order display region 662 to invoke an order completion action or to submit an order for payment or settlement or otherwise advance the order for further processing. For example, this gesture can include the use of two or more fingers in a swiping action within the on-screen interactive order display region 662. In an example embodiment, a two-finger swipe to the right side of the screen can be used to invoke a gesture-based order completion action related to the order currently displayed in the on-screen interactive order display region 662. In the example embodiment, a two-finger swipe to the left side of the screen within the on-screen interactive order display region 662 can be used to invoke a gesture-based order payment and/or settlement action related to the order currently displayed in the on-screen interactive order display region 662. As a result of either a two-finger right swipe or two-finger left swipe gesture within the on-screen interactive order display region 662, the user interface 606 will automatically present a pop-up display area 674 (see FIG. 13) to provide a region for presenting additional information for the user related to the invoked action and/or to accept additional user inputs related to the invoked action. The pop-up display area 674 will typically overlay and obscure at least a portion of the display screen and other user interface regions. The user can use the pop-up display area 674 to complete the gesture-based order completion action or the gesture-based order payment and/or settlement action related to the order currently displayed in the on-screen interactive order display region 662.

In an example embodiment, the user can also use gesture inputs to navigate within the pop-up display area 674. For example, these gestures within the pop-up display area 674 can include using one or two fingers in a swiping gesture to navigate to previous or next pages of a multi-page pop-up display area 674. In the example embodiment, a one or two finger swipe to the right side of the multi-page pop-up display area 674 can be used to navigate to a previous screen (page). A one or two finger swipe to the left side of the multi-page pop-up display area 674 can be used to navigate to a next screen (page). The user can also use other gestures to invoke other actions. For example, the user can use one or two fingers in a tapping gesture within the pop-up display area 674 to complete, exit, or close the pop-up display area 674 and return the user interface 606 to a focus within the on-screen interactive order display region 662. Additionally, the user can use one or two fingers in a vertical swiping gesture within the pop-up display area 674 to complete, exit, or close the pop-up display area 674 and return the user interface 606 to a focus within the on-screen interactive order display region 662. This embodiment enables the computerized order entry users quickly and effortlessly invoke key actions with finger gestures rather than finding related buttons and performing multiple user inputs to invoke desired actions.

In the described example embodiment, the computing device can be a point-of-sale/service (POS), kiosk-based device, or other device, such as computing device 112 or 1100, The computing device can be a computer or tablet with a touch display, whether multi-touch or not. The computing device can be executing an order entry application, which includes the user interface functionality as described herein. The order entry application can be accessible on the computing device, regardless if the application is natively installed or accessible via a remote desktop, web browser or otherwise.

### Example Embodiment 4

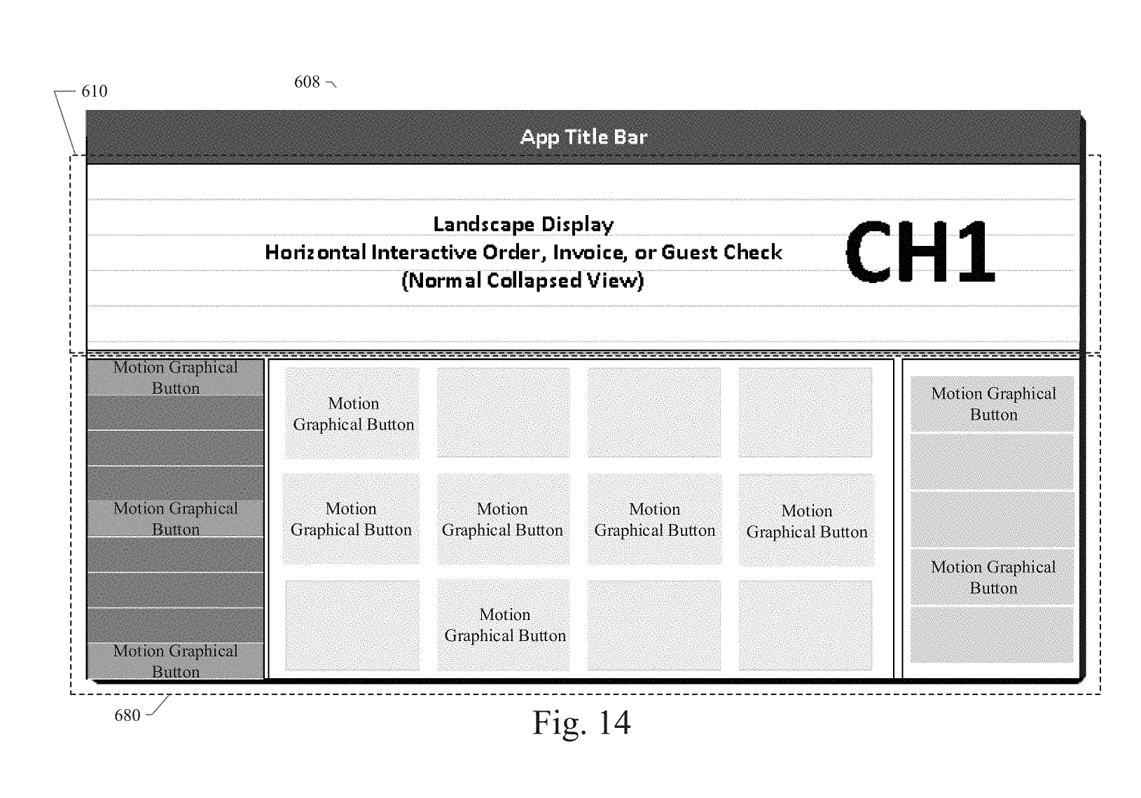

Referring now to FIG. 14, a diagram illustrates an example user interface screen snapshot of a user interface 608 implemented on a point-of-sale/service (POS), a kiosk-based device, or other device, such as computing device 112 or 1100. In such an example of a computerized order entry system, where a touch screen is utilized for its users to interface for the purpose of inputting and managing orders, the user interface 608 can be configured to include several regions, which serve specific purposes. For example as shown in FIG. 14, a horizontally-rendered on-screen interactive order display region 610 (e.g., invoice or guest check highlighted with a dashed rectangle) is where the user can review and edit what has already been ordered for accuracy and completeness. In this example, the on-screen interactive order display region 610 is horizontally rendered at the top of the display and extending to each side of the display. In an alternative embodiment, the on-screen interactive order display region 610 can be vertically rendered on a side of the display and extending to the top and bottom of the display. In the example shown in FIG. 14, the on-screen interactive order display region 610 is arranged in a horizontal or landscape configuration in a normally collapsed view where each of the other regions of the user interface 608 are visible. In this normally collapsed view, only a portion of the content of the on-screen interactive order display region 610 is typically visible to the user. In the example embodiment, the other regions of the user interface 608 can include a user input region 680 (highlighted with a dashed rectangle). The user input region 680 of user interface 608 represents a typical arrangement of buttons, icons, or other user input objects with which the user can select ordered items, invoke various functions related to the order entry system, or select, view, or edit a variety of other options available for a particular application or location in which the point-of-sale/service (POS), kiosk-based device, or other device, such as computing device 112 or 1100, is used. The ordered items selected via user input region 680 typically show up in the on-screen interactive order display region 610 as a running list of ordered items. In the example shown in FIG. 14, any of the user input objects (buttons) provided within user input region 680 can be invoked or selected via a user action. Typically, to order a particular item or activate a particular function, the user uses a single finger to tap (e.g., Single Finger Tap) one of the user input objects of user input region 680 corresponding to the desired item or function.

However, in many cases, the user is not sure which button to tap to order or activate the desired item or function. Often, because of the large quantity of buttons provided in user input region 680 and the relatively small size of the display device, the information identifying the items or functions corresponding to each button may be highly abbreviated or rendered in a small font. In any case, the user may be confused by the image, wording, or information provided for each button. As a result, the user may order the wrong item or activate an unwanted function, thereby causing delays and inefficiency. In other conventional POS user interfaces, the user may have an option to view additional information on the available items or functions; but, the additional information can only be accessed after multiple, time-consuming user inputs.

In a solution to this problem with conventional POS user interfaces, a fourth example embodiment is provided herein. In this example embodiment, any of the user input objects of the user input region 680 may be represented as a motion graphical button, which displays moving image content within the boundaries of each particular button. The moving image content can provide an animated or moving visual explanation or identification of the function of the corresponding button. This feature can be used to associate any of the POS order entry buttons that users operate with a motion graphical explanation of the purpose and use of the particular button to enhance clarity and understanding of the button purpose. This can be achieved by use of a motion graphical image rendered on one or more of the buttons of the user input region 680 to convey exactly the purpose of each button. This feature can be implemented by use of a single image file that supports motion graphics (such as a Graphics Interchange Format (GIF) file), so that a GIF file, for example, is linked to a particular button of the user input region 680. Because the example embodiment uses a single image file that supports motion graphics, the embodiment does not require the use of embedded video, a multi-picture rotating strategy, or linked video from the Internet, as these implementations are typically slow or cause a higher level of system resource utilization. In an example embodiment using the motion graphical button feature, all of the order entry menu item buttons, tender types, order types, payment types, seating objects, menu groups, menu modifiers, discounts, surcharges, and/or other user input selections can be represented as motion graphic image buttons instead of buttons represented with a text string or a still image. The motion graphical button feature of the example embodiment improves user understanding of the use and purpose of the underlying button about to be invoked.

In the described example embodiment, the computing device can be a point-of-sale/service (POS), kiosk-based device, or other device, such as computing device 112 or 1100, The computing device can be a computer or tablet with a touch display, whether multi-touch or not. The computing device can be executing an order entry application, which includes the user interface functionality as described herein. The order entry application can be accessible on the computing device, regardless if the application is natively installed or accessible via a remote desktop, web browser or otherwise.

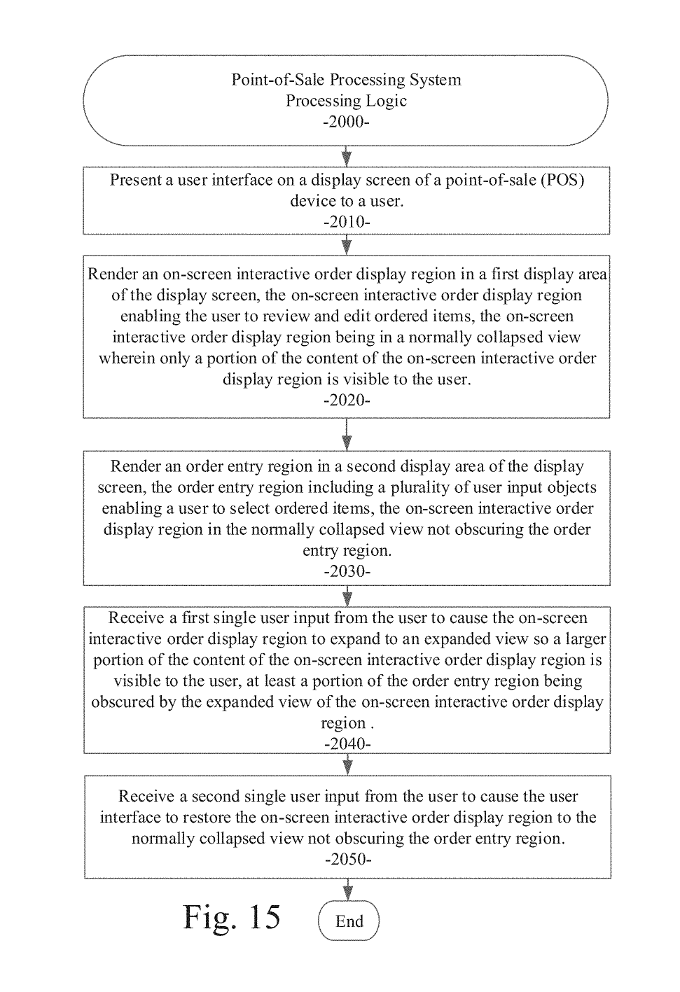

Referring now to FIG. 15, a processing flow diagram illustrates an example embodiment of a method implemented by the point-of-sale processing system as described herein. The method 2000 of an example embodiment includes: presenting a user interface on a display screen of a point-of-sale (POS) device to a user (processing block 2010); rendering an on-screen interactive order display region in a first display area of the display screen, the on-screen interactive order display region enabling the user to review and edit ordered items, the on-screen interactive order display region being in a normally collapsed view wherein only a portion of the content of the on-screen interactive order display region is visible to the user (processing block 2020); rendering an order entry region in a second display area of the display screen, the order entry region including a plurality of user input objects enabling a user to select ordered items, the on-screen interactive order display region in the normally collapsed view not obscuring the order entry region (processing block 2030); receiving a first single user input from the user to cause the on-screen interactive order display region to expand to an expanded view so a larger portion of the content of the on-screen interactive order display region is visible to the user, at least a portion of the order entry region being obscured by the expanded view of the on-screen interactive order display region (processing block 2040); and receiving a second single user input from the user to cause the user interface to restore the on-screen interactive order display region to the normally collapsed view not obscuring the order entry region (processing block 2050).

As described herein for various example embodiments, systems and methods for efficient navigation of an order entry system user interface are disclosed. In various embodiments, a software application program is used to enable the development, processing, and presentation of a user interface to improve the operation and efficiency of a user interface for POS and order entry devices. As such, the various embodiments as described herein are necessarily rooted in computer and network technology and serve to improve these technologies when applied in the manner as presently claimed. In particular, the various embodiments described herein improve the use of POS and mobile device technology and data network technology in the context of product and service purchase transactions via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
presenting a user interface on a display screen of a point-of-sale (POS) device to a user;
rendering an on-screen interactive order display region in a first display area of the display screen, the on-screen interactive order display region enabling the user to review and edit ordered items, the on-screen interactive order display region being in a normally collapsed view wherein only a portion of the content of the on-screen interactive order display region is visible to the user;
rendering an order entry region in a second display area of the display screen, the order entry region including a plurality of user input objects enabling a user to select ordered items, the on-screen interactive order display region in the normally collapsed view not obscuring the order entry region;
receiving a first single user input at one of the plurality of user input objects to cause presentation of an item information detail screen displaying additional information related to the one of the plurality of user input objects, at least a portion of the order entry region being obscured by the item information detail screen; and
receiving a second single user input from the user at the item information detail screen to cause the user interface to remove the item information detail screen.

2. The method of claim 1 wherein the on-screen interactive order display region is rendered in a horizontal or landscape configuration at the top of the display screen and extending to each side of the display screen.

3. The method of claim 1 wherein the on-screen interactive order display region is rendered in a vertical or portrait configuration on a side of the display screen and extending to the top and bottom of the display screen.

4. The method of claim 1 wherein the first single user input is a double finger tap on the one of the plurality of user input objects.

5. The method of claim 1 wherein the second single user input is a single finger tap on the item information detail screen.

6. A computer-implemented method comprising:
presenting a user interface on a display screen of a point-of-sale (POS) device to a user;
rendering an on-screen interactive order display region in a first display area of the display screen, the on-screen interactive order display region enabling the user to review and edit ordered items, the on-screen interactive order display region being in a normally collapsed view wherein only a portion of the content of the on-screen interactive order display region is visible to the user;
rendering an order entry region in a second display area of the display screen, the order entry region including a plurality of user input objects enabling a user to select ordered items, the on-screen interactive order display region in the normally collapsed view not obscuring the order entry region;
receiving a first single user input from the user in the on-screen interactive order display region to cause the user interface to either invoke an order completion action or to submit an order for payment or settlement, the first single user input further causing the user interface to automatically present a pop-up display area to provide a region for presenting additional information for the user on the invoked action or order submittal; and
receiving a second single user input from the user in the pop-up display area to cause the user interface to cause the pop-up display area to page through a plurality of information pages.

7. The method of claim 6 wherein the first single user input is a user gesture comprising a two-finger swipe to the right side of the display screen to invoke a gesture-based order completion action related to an order currently displayed in the on-screen interactive order display region.

8. The method of claim 6 wherein the first single user input is a user gesture comprising a two-finger swipe to the left side of the display screen to invoke a gesture-based order payment or settlement action related to an order currently displayed in the on-screen interactive order display region.

9. The method of claim 6 wherein the second single user input is a user gesture comprising a two-finger swipe to the right side of the display screen to navigate to a previous information screen of the pop-up display area.

10. The method of claim 6 wherein the second single user input is a user gesture comprising a two-finger swipe to the left side of the display screen to navigate to a next information screen of the pop-up display area.
